(19) United States
(12) Patent Application Publication
(10) Pub. No.: US 2025/0328633 A1
(43) Pub. Date: Oct. 23, 2025

(54) METHOD OF SECURITY INFORMATION VISUALIZATION PROCESSING, ELECTRONIC DEVICE AND STORAGE MEDIUM

(71) Applicant: Beijing Zitiao Network Technology Co., Ltd., Beijing (CN)

(72) Inventors: Aiping YANG, Beijing (CN); Qingqian Jiang, Beijing (CN); Die Fang, Beijing (CN); Bingjing Liu, Beijing (CN); Zheng Yang, Beijing (CN)

(21) Appl. No.: 19/169,984

(22) Filed: Apr. 3, 2025

(30) Foreign Application Priority Data
Apr. 17, 2024 (CN) 202410465706.9

(51) Int. Cl. G06F 21/54; G06F 21/55

(52) U.S. Cl. CPC G06F 21/54; G06F 21/552

(57) ABSTRACT

A method of security information visualization processing, an electronic device and a storage medium are provided. The method includes: in response to a security overview display instruction, displaying a security overview dashboard of a user group; displaying, in the security overview dashboard, anomaly aggregation information and security measure aggregation information; and aggregately displaying, in a display region corresponding to a security scenario, information of a plurality of anomaly categories associated with the security scenario.

### CROSS-REFERENCE TO RELATED APPLICATION

The present disclosure claims priority of the Chinese Patent Application No. 202410465706.9 filed on Apr. 17, 2024, the disclosure of which is incorporated herein by reference in its entirety as part of the present application.

### TECHNICAL FIELD

Embodiments of the present disclosure relate to a method of security information visualization processing, an electronic device, and a storage medium.

### BACKGROUND

A user group may have corresponding information assets, such as documents of the user group and user accounts in the user group. These information assets may face security issues. For example, the documents in the user group are sent outside the user group, and information leakage is caused by accounts accessing insecure websites, which may all lead to security issues of the information assets of the user group.

### SUMMARY

Embodiments of the present disclosure provide a method and apparatus of security information visualization processing, and an electronic device.

An embodiment of the present disclosure provides a method of security information visualization processing. The method includes: in response to a security overview display instruction, displaying a security overview dashboard of a user group; displaying, in the security overview dashboard, anomaly aggregation information and security measure aggregation information, where the anomaly aggregation information includes anomaly aggregation data respectively corresponding to a plurality of security scenarios; where the anomaly aggregation data corresponding to each security scenario is obtained based on: performing anomaly object identification on a plurality of pieces of log data based on an anomaly identification rule associated with the security scenario, and aggregating anomaly data of obtained anomaly objects; the security measure aggregation information includes information of a plurality of security measures corresponding to the user group and completion information of the plurality of security measures; and aggregately displaying, in a display region corresponding to the security scenario, information of a plurality of anomaly categories associated with the security scenario, where an anomaly category indicated by the anomaly category information is related to the anomaly identification rule.

An embodiment of the present disclosure provides an apparatus of security information visualization processing. The apparatus includes: a first display unit configured to display a security overview dashboard of a user group in response to a security overview display instruction; a second display unit configured to display anomaly aggregation information and security measure aggregation information in the security overview dashboard, where the anomaly aggregation information includes anomaly aggregation data respectively corresponding to a plurality of security scenarios; where the anomaly aggregation data corresponding to each security scenario is obtained based on: performing anomaly object identification on a plurality of pieces of log data based on an anomaly identification rule associated with the security scenario, and aggregating anomaly data of obtained anomaly objects; the security measure aggregation information includes information of a plurality of security measures corresponding to the user group and completion information of the plurality of security measures; and a third display unit configured to aggregately display information of a plurality of anomaly categories associated with the security scenario in a display region corresponding to the security scenario, where an anomaly category indicated by the anomaly category information is related to the anomaly identification rule.

An embodiment of the present disclosure provides an electronic device, including: a processor and a memory; where the memory stores computer-executable instructions; and the processor executes the computer-executable instructions stored in the memory, so that the at least one processor executes the method according to the above and various possible methods of the above.

An embodiment of the present disclosure provides a computer-readable storage medium. The computer-readable storage medium stores computer-executable instructions. When a processor executes the computer-executable instructions, the method according to the above and various possible methods of the above is implemented.

An embodiment of the present disclosure provides a computer program product, including a computer program, where when the computer program is executed by a processor, the method according to the above and various possible methods of the above is implemented.

### BRIEF DESCRIPTION OF DRAWINGS

In order to illustrate the technical solutions in the embodiments of the present more clearly, the drawings required in describing the embodiments will be briefly introduced below. Apparently, the drawings in the following description are some embodiments of the present disclosure. For those of ordinary skill in the art, other drawings may be obtained according to these drawings without creative efforts.

FIG. 1 is a first schematic flowchart of a method security information visualization processing according to an embodiment of the present disclosure;

FIG. 2 is a schematic diagram of an application scenario;

FIG. 3 is a second schematic flowchart of a method of security information visualization processing according to an embodiment of the present disclosure;

FIG. 4 is a schematic diagram of an application scenario;

FIG. 5 is a schematic diagram of an application scenario;

FIG. 6 is a third schematic flowchart of a method of security information visualization processing according to an embodiment of the present disclosure;

FIG. 7 is a schematic diagram of an application scenario;

FIG. 8 is a schematic diagram of an application scenario;

FIG. 9 is a schematic diagram of an application scenario;

FIG. 10 is a structural block diagram of an apparatus of security information visualization processing according to an embodiment of the present disclosure; and

FIG. 11 is a schematic structural diagram of hardware of an electronic device according to an embodiment of the present disclosure.

### DETAILED DESCRIPTION

In order to make the objectives, technical solutions, and advantages of the embodiments of the present disclosure clearer, the technical solutions in the embodiments of the present disclosure will be described clearly and completely below with reference to the drawings in the embodiments of the present disclosure. Obviously, the described embodiments are part of the embodiments of the present disclosure, but not all of them. Based on the embodiments in the present disclosure, all other embodiments obtained by those of ordinary skill in the art without creative efforts fall within the protection scope of the present disclosure.

A user group may include a plurality of users. The plurality of users may edit and store a plurality of documents (for example, online documents) belonging to the user group through an application client, and different users in the user group may communicate information through the application client. Documents belonging to the user group, data for information communication between users in the user group, user accounts of different users, and the like may be regarded as information assets of the user group.

The information assets of the user group may have information security issues, for example, documents in the user group are leaked outside the user group, user accounts belonging to the user group are attacked, and so on. In order to detect and/or protect information security issues of the user group as soon as possible, a security rule may be set, and alert information or a security event may be triggered according to the security rule.

In the related art, an alert information list may be displayed to a user, or a security event list may be displayed to the user. The above alert information list and security event list are just simple lists of the alert information and the security events, and cannot help the user quickly understand overall security issues and implementation of protection measures in the user group. In addition, the emerging security issues are not displayed from a security scenario of interest to the user, so the user cannot be helped to understand the security issues emerging in the user group. Therefore, the user may be delayed in handling the security issues, resulting in continuous security issues of information in the user group.

In this embodiment, a security overview dashboard is provided, the corresponding anomaly aggregation information and security measure aggregation information are displayed in the security overview dashboard in terms of security scenarios, and the information of the plurality of anomaly categories associated with the security scenario is aggregately displayed, so that the user can globally understand the security issues and security measures in the user group from a familiar application scenario, so as to quickly handle the security issues corresponding to the user group and timely implement security measures for preventing the security issues, thereby better protecting information of the user group.

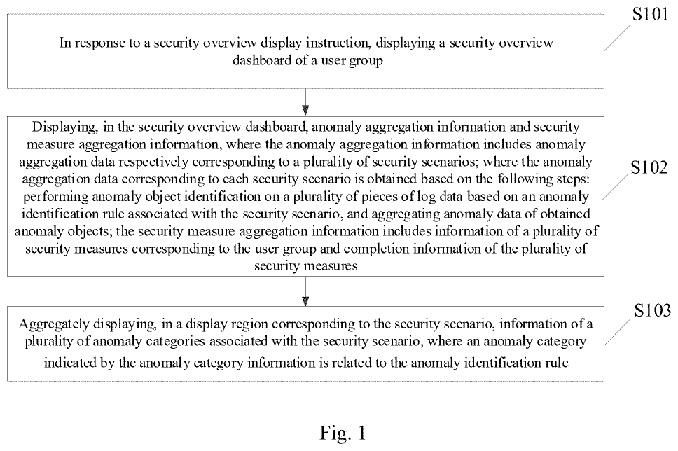

Referring to FIG. 1, FIG. 1 is a first schematic flowchart of a method of security information visualization processing according to an embodiment of the present disclosure. As shown in FIG. 1, the method includes the following steps.

S101, displaying a security overview dashboard of a user group in response to a security overview display instruction.

In this embodiment, an execution subject of the method of security information visualization processing may be a terminal device, and may specifically be an application client running on the terminal device.

The user group here may be any user group including a plurality of users. The user group may have information assets generated by the plurality of users in the user group, such as documents edited by the users, interactive data for information communication between the users, user accounts, and the like.

In an interface of the above application client, a security overview control for globally previewing information security status (including anomaly information and protection measures) of the user group may be provided. The user may perform a trigger operation on the above security overview control to send a security overview display instruction to the above execution subject. After receiving the above security overview display instruction, the above execution subject may display the security overview dashboard of the user group.

S102: displaying anomaly aggregation information and security measure aggregation information in the security overview dashboard, where the anomaly aggregation information includes anomaly aggregation data respectively corresponding to a plurality of security scenarios; where the anomaly aggregation data corresponding to each security scenario is obtained based on: performing anomaly object identification on a plurality of pieces of log data based on an anomaly identification rule associated with the security scenario, and aggregating anomaly data of obtained anomaly objects; the security measure aggregation information includes information of a plurality of security measures corresponding to the user group and completion information of the plurality of security measures.

The anomaly aggregation information here displays the aggregation information of a plurality of security anomalies that have occurred, and the security measure aggregation information is the aggregation information of a plurality of security measures. The security measures may be set from the perspective of preventing security issues of the user group.

That is, in the security overview dashboard, the anomaly aggregation information of the plurality of security anomalies that have occurred at present and the security measure aggregation information used to prevent security issues of the information of the user group may be browsed.

The above log data may include, for example, an event log, a behavior log, and the like. The above event log may include event records such as logging in to a system corresponding to the user group and logging out of the system by a plurality of accounts.

The behavior log here includes behavior logs of a plurality of users in the user group. The behavior log of the user includes, for example, behavior records such as exporting, sharing, and deleting information assets of the user group by the user.

In order to facilitate the user to understand security anomalies emerging in the user group, security scenarios that are convenient for the user to understand may be extracted. Starting from these security scenarios, information security anomalies emerging in the user group are aggregated. The anomaly aggregation results corresponding to the security scenarios are presented to the user in the security overview dashboard. That is, the anomaly aggregation information displayed in the dashboard is formed by aggregating the anomaly aggregation data respectively corresponding to the plurality of security scenarios. Therefore, the user can browse, in the dashboard, the anomaly aggregation data obtained by aggregating the security issue data emerging in the user group in terms of different application scenarios.

The security scenario here may be a security scenario familiar to the user, and the security scenario may include one or more of the following: a content security scenario, an account security protection scenario, and an abnormal account protection scenario.

The account security protection scenario here is a scenario for protecting a normal account of a user, for example, to prevent the normal account from being deliberately attacked, stolen, and the like.

The abnormal account protection scenario here may be to manage a designated account that is known to may cause security issues to the information of the user group. Users are prevented from stealing information through these abnormal accounts.

In the above application client, a plurality of anomaly identification rules may be pre-stored, such as a rule for identifying frequent exporting, a rule for identifying being deleted, a rule for identifying frequent external sharing, a rule for identifying frequent addition of collaborators, a rule for identifying frequent authority setting modification, a rule for identifying frequent copying, a rule for identifying abnormal account login, a rule for identifying abnormal chat, a rule for identifying clicking on abnormal network links, and so on.

For each security scenario, a plurality of anomaly identification rules may be associated with the security scenario, and the plurality of anomaly identification rules may be used to perform anomaly object identification on a plurality of pieces of log data, so as to obtain a plurality of anomaly objects corresponding to the security scenario.

The anomaly objects may include, but are not limited to: anomalous content, abnormal events, abnormal accounts, and the like.

The anomaly identification rules associated with the security scenario here may be anomaly identification rules defaulted by the application program or may be anomaly identification rules set by the user.

Illustratively, for exporting anomalies, a corresponding anomaly identification rule may be that the number of exports in one day is greater than or equal to a first preset number threshold. According to the anomaly identification rule, content that is exported more than the first preset threshold in one day is an anomaly object. The first preset number threshold here may be, example, 10 times.

In the security scenario of account security protection, each anomaly identification rule corresponding to the security scenario may be provided by the application program. For example, the anomaly identification rule corresponding to abnormal login may be, for example, logging in from an unusual login place.

For the security scenario of abnormal account protection, the anomaly identification rule of the security scenario may be that the number of times that an abnormal account performs the same operation is greater than a second preset number threshold. If the number of times that an abnormal account performs the same operation is greater than the second preset number threshold, the abnormal account is an anomaly object. The second preset number threshold here may be set according to a specific application scenario, which is not limited here.

After identifying a plurality of anomaly objects by using the respective anomaly identification rules, anomaly data of the respective anomaly objects may be aggregated to obtain the anomaly aggregation data corresponding to the security scenario. For example, the plurality of anomaly objects identified by the of the respective anomaly identification rules may be deduplicated, and then the number of deduplicated anomaly objects may be aggregated.

For the content security scenario, if the anomaly object is a document, the number of deduplicated documents may be accumulated, and the accumulated number may be used as the anomaly aggregation data of the security scenario. For the abnormal account protection scenario, the number of deduplicated abnormal accounts may be accumulated, and the obtained total number of abnormal accounts may be used as the anomaly aggregation data of the security scenario.

The information of the security measure includes an identifier of the security measure and/or a security issue to be protected. The completion information of the security measure includes information of applied security measures, information of unapplied security measures, and a proportion of the applied security measures in the total security measures.

The applied security measures are security measures that have been applied to the information security protection of the user group. The unapplied security measures are security measures that have not been applied to the information security protection of the user group.

For example, the following information may be displayed in a security measure aggregation information display region of the security overview dashboard: information of the above proportion, information of the plurality of unapplied security measures, and information of the plurality of applied security measures.

S103, aggregately displaying, in a display region corresponding to the security scenario, information of a plurality of anomaly categories associated with the security scenario, where an anomaly category indicated by the anomaly category information is related to the anomaly identification rule.

In the above security overview dashboard, the anomaly information of different security scenarios may be displayed separately. For each security scenario, there is a corresponding display region in the security overview dashboard. In the display region corresponding to the security scenario, the information of the plurality of anomaly categories associated with the security scenario is aggregately displayed.

The information of the anomaly category includes an identifier of the anomaly category and anomaly aggregation data corresponding to the anomaly category.

The above anomaly category is related to the anomaly identification rule. For example, one anomaly category is determined for each anomaly identification rule, or more than one anomaly identification rule is grouped into one anomaly category. The anomaly category is determined according to the anomaly identification rule according to a specific application scenario.

For each anomaly identification rule, after the above step S102, information of a plurality of anomaly objects identified by the anomaly identification rule may be recorded. Data of the plurality of anomaly objects corresponding to the anomaly identification rule is aggregated to obtain the anomaly aggregation data corresponding to the anomaly identification rule. The above aggregating the data of the plurality of anomaly objects corresponding to the anomaly identification rule to obtain the anomaly aggregation data corresponding to the anomaly identification rule includes: accumulating the plurality of anomaly objects identified by the anomaly identification rule to obtain the anomaly aggregation data corresponding to the anomaly identification rule.

For each anomaly category, the anomaly aggregation data corresponding to the anomaly category may be determined by the anomaly aggregation data corresponding to the anomaly identification rule associated with the anomaly category.

In some application scenarios, one anomaly category may be determined for each anomaly identification rule. In this application scenario, the anomaly aggregation data corresponding to an anomaly identification rule may be used as the anomaly aggregation data of the corresponding anomaly category.

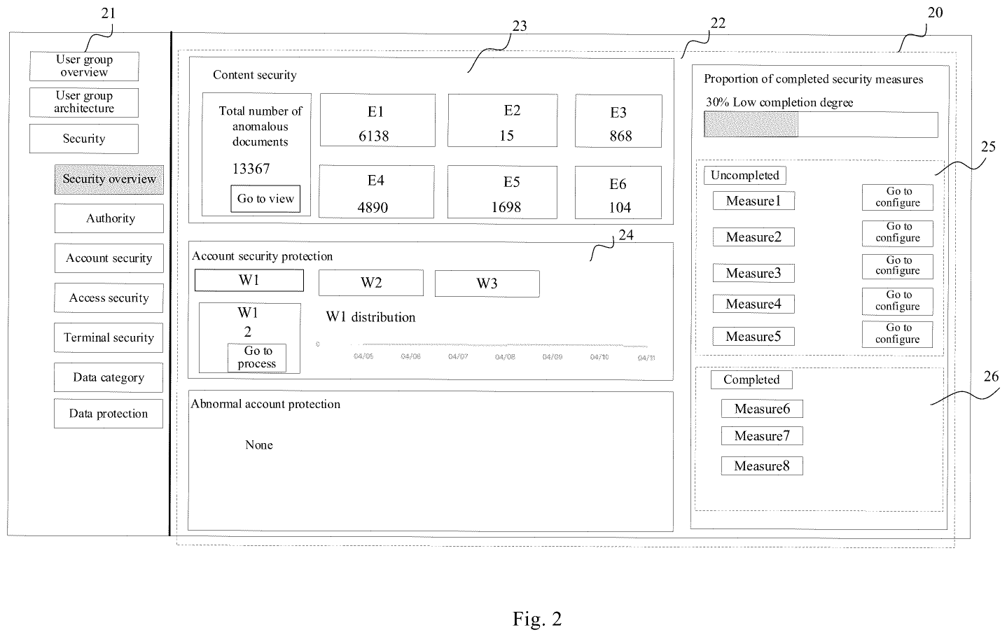

Referring to FIG. 2, FIG. 2 is a schematic diagram of an application scenario. As shown in FIG. 2, an application program client interface 20 used by a user group may display user group overview information 21. The user group overview information 21 includes a user group organization structure item and a security item. The security item may include a security-related list. The security-related list includes a security overview option, an authority option, an account security option, an access security option, a terminal security option, a data protection security option, and the like. The user may perform a selection operation on the security overview option (which may be regarded as a security overview control) to send a security overview instruction to the execution subject. The above execution subject may display a security overview dashboard 22 of the user group in the above interface 20 according to the above security overview instruction.

The above security overview dashboard 22 may display anomaly aggregation information and security measure aggregation information.

The security measure aggregation information may include, for example, a proportion of completed security measures, where the proportion of completed security measures is a proportion of the applied security measures in the total security measures, for example, 30% in FIG. 2. In addition, information about the completion degree of the security measures may also be displayed at an associated position (for example, in the vicinity) of the information of the above proportion, such as “Low completion degree” in FIG. 2.

The security measure aggregation information also includes a plurality of security measures that have not been applied to the information security protection of the user group, such as “Measure 1”, “Measure 2”, “Measure 3”, “Measure 4”, and “Measure 5” in FIG. 2, and a plurality of security measures that have been applied to the information security protection of the user group, such as “Measure 6”, “Measure 7”, and “Measure 8” in FIG. 2.

The anomaly aggregation information is displayed in the above security overview dashboard 22. The anomaly aggregation information includes the anomaly aggregation data respectively corresponding to the plurality of security scenarios, such as the anomaly aggregation data corresponding to the content security scenario, the anomaly aggregation data corresponding to the account security protection, and the anomaly aggregation data corresponding to the abnormal account protection in FIG. 2.

In the security overview dashboard 22 shown in FIG. 2, the anomaly aggregation data corresponding to the plurality of security scenarios may be displayed in terms of security scenarios, and the information of the plurality of anomaly categories associated with each security scenario may be aggregately displayed in a display region corresponding to each security scenario.

For the content security scenario in FIG. 2, the anomaly aggregation data of the security scenario includes, for example, that the number of anomalous documents is 13,367.

In addition, the information of the anomaly categories associated with the content security scenario is aggregately displayed in the region 23 of the content security scenario. As shown in FIG. 2, the following information of anomaly categories associated with the content security scenario is displayed in the display region 23. The information of the anomaly category includes anomaly category identifiers E1, E2, E3, E4, E5, and E6. In addition, the anomaly aggregation data corresponding to the respective anomaly categories may also be displayed. For example, in FIG. 2, the anomaly aggregation data corresponding to the anomaly category E1 is 6138, the anomaly aggregation data of the anomaly category E2 is 15, the anomaly aggregation data corresponding to the anomaly category E3 is 868, the anomaly aggregation data corresponding to the anomaly category E4 is 4890, the anomaly aggregation data corresponding to the anomaly category E5 is 1698, and the anomaly aggregation data corresponding to the anomaly category E6 is 104.

As shown in the scenario of account security protection in FIG. 2, the anomaly aggregation data corresponding to the account security protection scenario is displayed. The information of the anomaly categories is aggregately displayed in the display region 24 of the scenario of account security protection. The information of the anomaly category includes, for example, category identifiers, and the category identifiers include information of W1, W2, and W3. A target anomaly category may be selected from the plurality of anomaly categories in the above account security protection scenario, and anomaly data and anomaly distribution information of the target anomaly category may be displayed. For example, the anomaly category W1 in FIG. 2 is selected, and the anomaly aggregation data corresponding to the abnormal account login, such as “W1”, is displayed in the above region 24, as well as the anomaly distribution information corresponding to the anomaly category W1.

In this embodiment, the security overview dashboard of the user group is displayed in response to the security overview display instruction; the anomaly aggregation information and the security measure aggregation information are displayed in the security overview dashboard, where the anomaly aggregation information includes the anomaly aggregation data respectively corresponding to the plurality of security scenarios; the anomaly aggregation data corresponding to each security scenario is obtained based on: performing the anomaly object identification on the plurality of pieces of log data based on the anomaly identification rule associated with the security scenario, and aggregating the anomaly data of the obtained anomaly objects; the security measure aggregation information includes the information of the plurality of security measures corresponding to the user group and the completion information of the plurality of security measures; and the information of the plurality of anomaly categories associated with the security scenario is aggregately displayed in the display region corresponding to the security scenario, where the anomaly category indicated by the anomaly category information is related to the anomaly identification rule, so that the anomaly aggregation information and the security measure aggregation information are displayed in the security overview dashboard in terms of security scenarios, and the information of the plurality of anomaly categories associated with the security scenario is aggregately displayed. Thus, the user can globally understand the information security status in the user group from a familiar application scenario, and quickly handle the information security issue corresponding to the user group.

In some optional implementations, the method of security information visualization processing further includes the following steps.

First, a modification instruction for modifying an anomaly identification rule is received.

Then, the anomaly identification rule is modified according to the modification instruction.

As an implementation, an anomaly identification rule configuration entry may be displayed in the above security overview dashboard, that is, the security overview dashboard includes the anomaly identification rule configuration entry, and the receiving the modification instruction for modifying the anomaly identification rule includes: receiving the modification instruction sent based on an operation on the rule configuration entry.

The above anomaly identification rule configuration entry is used to modify at least one anomaly identification rule. The user may perform a trigger operation on the above anomaly identification rule configuration entry, thereby sending the above modification instruction to the application program client. After receiving the above modification instruction, the above application client may display a corresponding anomaly identification rule configuration interface.

In the anomaly identification rule configuration interface, the anomaly identification rule may be modified according to the operation of the user.

In these optional implementations, the anomaly identification rule may be modified. Therefore, the corresponding anomaly identification rule may be set according to a specific application scenario, and the information security anomalies of the user group may be identified more accurately, which is beneficial to the information security of the user group.

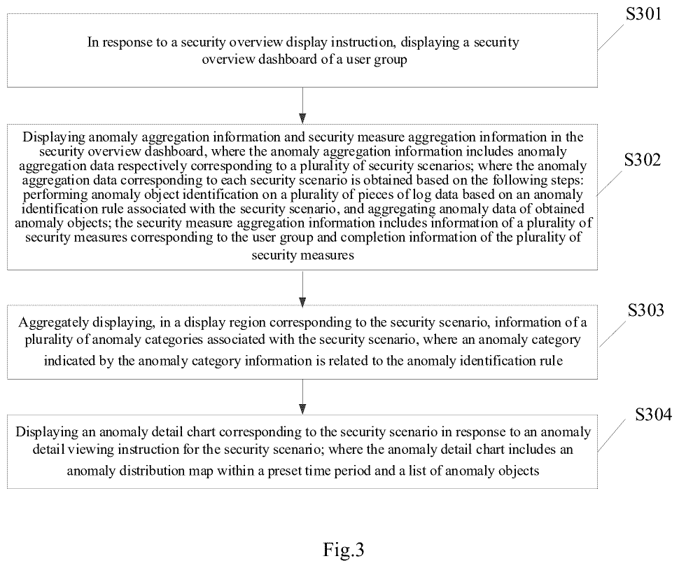

Referring to FIG. 3, FIG. 3 is a second schematic flowchart of a method of security information visualization processing according to an embodiment of the present disclosure. As shown in FIG. 3, the method includes the following steps.

S301, displaying a security overview dashboard of a user group in response to a security overview display instruction.

In this embodiment, an execution subject of the method of security information visualization processing may be a terminal device, and may specifically be an application program client running on the terminal device.

S302: displaying anomaly aggregation information and security measure aggregation information in the security overview dashboard, where the anomaly aggregation information includes anomaly aggregation data respectively corresponding to a plurality of security scenarios; where the anomaly aggregation data corresponding to each security scenario is obtained based on: performing anomaly object identification on a plurality of pieces of log data based on an anomaly identification rule associated with the security scenario, and aggregating anomaly data of obtained anomaly objects; the security measure aggregation information includes information of a plurality of security measures corresponding to the user group and completion information of the plurality of security measures.

S303: aggregately displaying, in a display region corresponding to the security scenario, information of a plurality of anomaly categories associated with the security scenario, where an anomaly category indicated by the anomaly category information is related to the anomaly identification rule.

In this embodiment, for the specific implementations of the above steps S301 to S303, reference may be made to the descriptions corresponding to steps S101 to S103 in the embodiment shown in FIG. 1, which will not be repeated here.

S304, displaying an anomaly detail chart corresponding to the security scenario in response to an anomaly detail viewing instruction for the security scenario; where the anomaly detail chart includes an anomaly distribution map within a preset time period and a list of anomaly objects.

In some embodiments, a first viewing control for viewing the anomaly detail of the security scenario may also be displayed in the security overview dashboard; and in this implementation, the method further includes the following step: receiving the anomaly detail viewing instruction triggered by performing a preset operation on the first viewing control of the security scenario.

In some application scenarios, the above first viewing control may be displayed in the display regions respectively corresponding to the respective security scenarios. The first viewing control of each security scenario is used to trigger the anomaly detail viewing instruction of the security scenario. In these application scenarios, the user may perform a preset operation on the first viewing control in any security scenario to trigger the anomaly detail viewing instruction corresponding to the security scenario. After receiving the anomaly detail viewing instruction for the security scenario, the above execution subject may display the anomaly detail chart of the security scenario. The above preset operation includes operations such as clicking, touching, and the like.

In some application scenarios, one first viewing control may be displayed in the security overview dashboard. The user may first select a security scenario, and then perform a preset operation on the first viewing control, so as to trigger the anomaly detail viewing instruction for the security scenario.

In this embodiment, the plurality of security scenarios presented in the security overview dashboard may include a content security scenario, an account security protection scenario, and an abnormal account protection scenario.

The user may perform the anomaly detail viewing instruction for any one of the security scenarios. According to the received anomaly detail viewing instruction performed for a security scenario, the anomaly detail chart corresponding to the security scenario may be displayed.

The above anomaly detail chart may include an anomaly distribution map within a preset time period and a list of anomaly objects. The preset time period here may be a time period set by the user.

In some application scenarios, the above anomaly distribution map is an anomaly object number change trend map composed of the number of anomaly objects at different times within the preset time period. The above anomaly object number change trend map also includes information about the number of anomaly objects in a reference time period.

In the anomaly object number change trend map within the preset time period, it is determined, by referring to the information about the number of anomaly objects in the reference time period, whether an anomaly in an anomalous time period indicates that a relatively large security issue has occurred.

The above list of anomaly objects may include anomaly information corresponding to a plurality of anomaly objects respectively. In the content security scenario, the anomaly object may include, for example, content (such as a document) in which an anomaly occurs. The anomaly information of the above anomaly object includes an anomaly object identifier, an anomaly category (anomaly tag), anomaly time, and the like.

In some embodiments, the security scenario is a content security scenario, and the list of anomaly objects includes at least one piece of anomalous content whose content state is a to-be-concerned state;

The content state includes the to-be-concerned state and a no-need-to-concern state, and the content state of the content is determined according to a content state determination rule, and the content state determination rule is used for determining the content state according to an anomaly identification rule corresponding to the anomalous content and/or a frequency of anomalies.

In these embodiments, a content state determination rule may be preset. For content in which no anomaly occurs, the state of the content is the no-need-to-concern state. For content in which an anomaly occurs, the above execution subject determines, according to the above content state determination rule, that the content state of the content is changed to the to-be-concerned state.

The above content state determination rule may include, for example, that provided that an anomaly corresponding to a first preset anomaly identification rule occurs, the content state is set to the to-be-concerned state.

For another example, a plurality of second preset anomaly identification rules may be set, and an anomaly frequency threshold corresponding to the second preset anomaly identification rules may be set. For a piece of content, if the content is identified as anomalous content by a plurality of second preset identification rules within a preset time period respectively, an actual anomaly occurrence frequency of the content within the preset time period is compared with the anomaly frequency threshold, and if the actual anomaly occurrence frequency exceeds the anomaly frequency threshold, the content state of the content is set to the to-be-concerned state.

When there are many anomalies, by displaying, in the list of anomaly objects, information of one or more pieces of content whose content state is the to-be-concerned state, the user can quickly know the anomalous content that needs to be concerned on, so as to perform corresponding security protection for the anomalous content that needs to be concerned on, thereby ensuring the information security of the user group.

It may be understood that in the list of anomaly objects, a state change control for changing a user state may also be displayed, and the to-be-concerned state of the content may be changed to the no-need-to-concern state by performing a trigger operation on the state change control, so that the content state may be changed by the user.

After the user changes the content state of a piece of content to the no-need-to-concern state, anomaly information of the content may no longer be displayed in the list of anomaly objects. That is, after the state of a piece of content is determined to be the to-be-concerned state according to the content state determination rule, the user determines whether the content really needs to be concerned. After the user determines that there is no need to concern, the user may perform a corresponding operation on the state change control to change the content state of the content to the no-need-to-concern state, and then the list of anomaly objects presents to the user the anomalous content that really needs to be concerned on by the user.

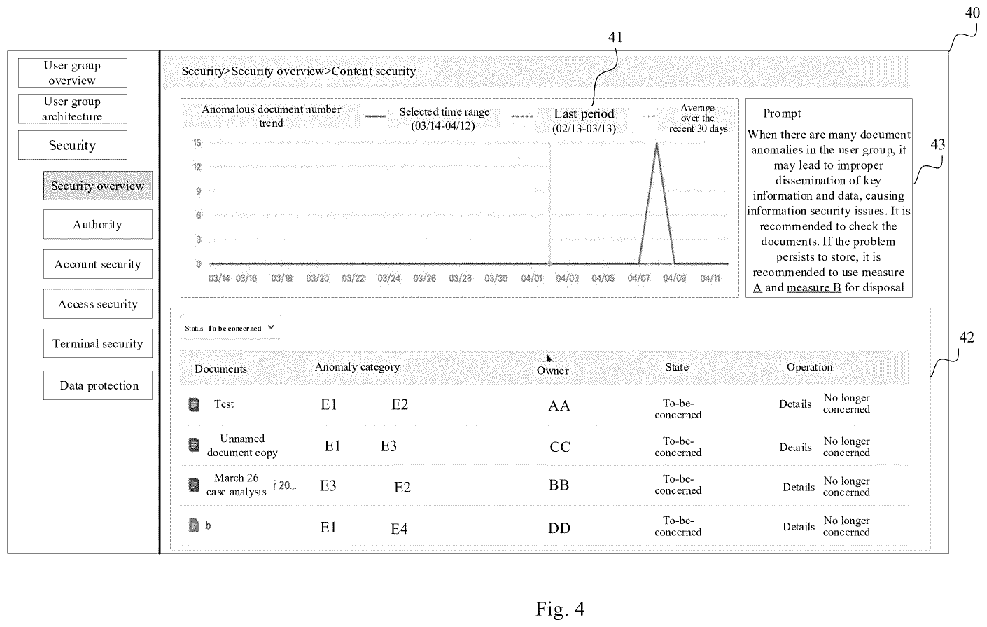

Please refer to FIG. 2 in combination with FIG. 4. FIG. 4 is a schematic diagram of an application scenario. The user may perform a corresponding anomaly detail viewing instruction for the content security application scenario. For example, a preset operation is performed on the first viewing control “Go to view” in the display region 23 in FIG. 2, so as to trigger the anomaly detail viewing instruction. After receiving the anomaly detail viewing instruction, the anomaly detail chart corresponding to the content security scenario may be displayed. As shown in FIG. 4, after the anomaly detail viewing instruction is received, a display interface 40 is displayed. The anomaly detail chart is displayed in the interface 40. The anomaly detail chart includes an anomaly distribution map 41 within a preset time period, and a list of anomaly objects including a plurality of anomaly objects.

The anomaly distribution map 41 presents a change trend of the number of anomalous documents during the period from March 14 to April 12. It can be seen from the above anomaly distribution map that the number of anomalous documents is prominent from April 7 to April 9.

As shown in FIG. 4, a plurality of anomalous documents whose content state is the to-be-concerned state are displayed in the list of anomaly objects 42. In the list of anomaly objects 42, identifiers of the anomalous documents are displayed, such as “Test”, “Unnamed document copy”, “March 36 case analysis”, “b”, anomaly categories, owners, document states, etc. corresponding to the anomalous documents. For example, the owners corresponding to the anomalous documents “Test”, “Unnamed document copy”, “March 36 case analysis”, and “b” are “AA”, “CC”, “BB”, and “DD”, respectively. For example, the anomaly categories corresponding to the anomalous document “Test” are “E1” and “E2”; for example, the anomaly categories corresponding to the anomalous document “Unnamed document copy” are “E1” and “E3”; for example, the anomaly tags corresponding to the anomalous document “March 36 case analysis” are “E3” and “E2”, etc. For example, the anomaly categories corresponding to the anomalous document “b” are “E1” and “E4”. The content states corresponding to the above anomalous documents are all the to-be-concerned state.

In the above list of anomaly objects 42, a state change control may be displayed, such as a state change control identified as “No longer concerned” in FIG. 4. The user may perform a trigger operation on the state change control corresponding to an anomalous document, so that the to-be-concerned state of the anomalous document may be changed to the no-need-to-concern state. For example, the state of “Test” is changed to the no-need-to-concern state. After the anomaly chart is updated, the document “Test” is no longer displayed in the list of anomaly objects 42.

In the content security scenario, by displaying the anomaly aggregation data of the content security scenario to the user, the user is presented with overall information security-related anomalies in the user group from the perspective of the content security of the user group. In addition, by displaying the information of the plurality of anomaly categories to the user, it is convenient for the user to know the distribution of anomalies of the content assets of the user group in each anomaly category, so as to know anomalies corresponding to which anomaly categories exist. In addition, by displaying the content anomaly distribution within the preset time period to the user, the anomaly changes of the content anomalies within the preset time period can be learned. By displaying the list of content anomalies to the user, it is convenient for the user to browse the anomaly information specific to a single piece of content in the list of content anomalies. Therefore, overall anomaly information to the anomaly information of a single piece of content may be presented to the user, so that the user can grasp the security status of the content in the user group from different dimensions.

In the security scenario of account security protection, the anomaly distribution map and the anomaly cause distribution map of different anomaly categories in the security scenario may be presented to the user according to the above operation of the user, and the list of anomaly objects may be displayed. The anomaly object here is an abnormal event. The abnormal events are classified according to the anomaly identification rule to obtain the corresponding anomaly categories of the security scenario, such as W1, W2, and W3, etc.

In the security scenario of account security protection, the anomaly-related alarm information accumulated by the user group within the set time period will be displayed in the form of a chart. These alarm information means that the accounts of the user group have security anomalies. It is helpful for the user to handle the anomalies corresponding to the accounts of the user group and protect the information security of the user group.

For the security scenario of abnormal account protection, authority management needs to be performed for operations on abnormal accounts to protect subsequent information security of the user group.

In this embodiment, the content of displaying the anomaly detail chart corresponding to the security scenario in response to the anomaly detail viewing instruction for the security scenario is described, which is convenient for presenting anomaly distribution information within a preset time period to the user, so that the user can know at which times the anomalies are mainly distributed, which objects have anomalies, and whether these objects need to be protected, etc., which is helpful for the information security of the user group.

In some embodiments, the method further includes: displaying an object anomaly information interface of a target anomaly object in response to receiving an anomaly object detail display instruction triggered based on an anomaly object detail control. The target anomaly object is an anomaly object indicated by the anomaly object detail display instruction, and the object anomaly information interface includes anomaly detail information corresponding to the target anomaly object.

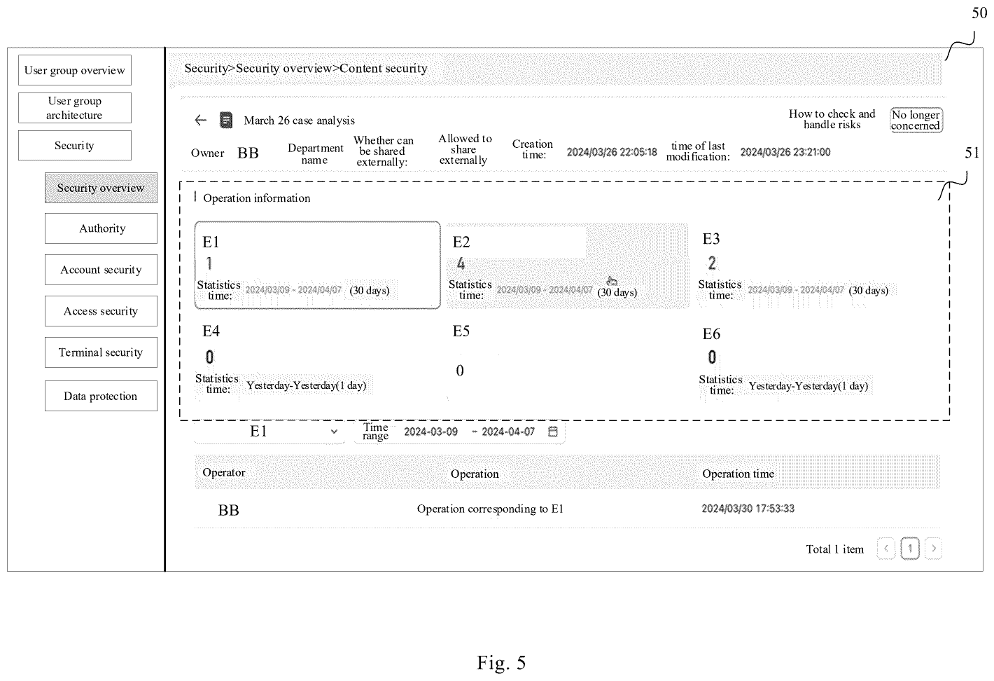

Please refer to FIG. 4 and FIG. 5. FIG. 5 is a schematic diagram of an application scenario. As shown in FIG. 4, the interface 40 may display anomaly object detail controls, such as anomaly object detail controls “Details” corresponding to the respective anomaly documents in the anomaly list 42. The user may perform a trigger operation on the anomaly object detail control corresponding to the anomalous document “March 36 case analysis”, so as to display an object anomaly information interface 50 corresponding to the anomalous document “March 36 case analysis”. In the object anomaly information interface, anomaly detail information of the anomalous document “March 36 case analysis” is displayed, such as including operation information 51. The operation information 51 includes corresponding anomaly categories and corresponding numbers of anomaly operations within the preset time period. For example, in FIG. 5, the anomaly category is E1, and the number of anomaly operations is “1”; the anomaly category is E2, and the number of anomaly operations is “4”; the anomaly category is E3, and the number of anomaly operations is “2”; the anomaly category is E4, and the number of anomaly operations is “0”; the anomaly category is E5, and the number of anomaly operations is “0”; the anomaly category is E6, and the number of anomaly operations is “0”, etc.

For each anomaly category, anomaly operation detail information corresponding to the anomaly category may be displayed in the interface 50. For example, if the category of frequent external sharing is selected, the anomaly operation detail information corresponding to the anomaly category E1 may be displayed in the object anomaly information interface 50, as shown in FIG. 5, the operator is “BB”, the specific operation is “Operation corresponding to E1”, and the operation time is “2024/03/30 17:53:33”.

The object anomaly information interface is displayed through the anomaly object detail display instruction, so that the user can browse, in the dimension of the anomaly object, the anomaly category corresponding to the anomaly object and the specific anomaly operation details corresponding to the respective anomaly categories, which is convenient for the user to know the anomaly information details of the anomaly object, so as to determine whether to perform further security protection for the anomaly object.

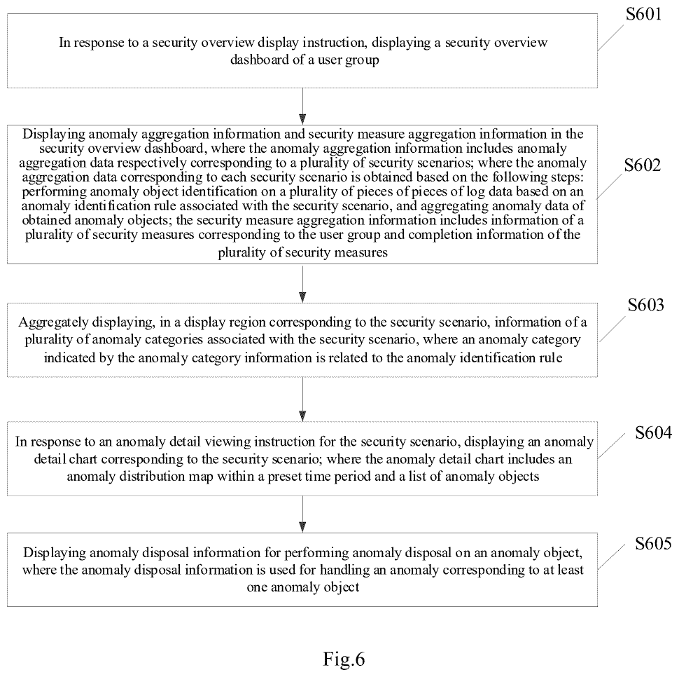

Referring to FIG. 6, FIG. 6 is a third schematic flowchart of a method of security information visualization processing according to an embodiment of the present disclosure. As shown in FIG. 6, the method includes the following steps.

S601, displaying a security overview dashboard of a user group in response to a security overview display instruction.

In this embodiment, an execution subject of the method of security information visualization processing may be a terminal device, and may specifically be an application program client running on the terminal device.

S602, displaying anomaly aggregation information and security measure aggregation information in the security overview dashboard, where the anomaly aggregation information includes anomaly aggregation data respectively corresponding to a plurality of security scenarios. The anomaly aggregation data corresponding to each security scenario is obtained based on: performing anomaly object identification on a plurality of pieces of log data based on an anomaly identification rule associated with the security scenario, and aggregating anomaly data of obtained anomaly objects; the security measure aggregation information includes information of a plurality of security measures corresponding to the user group and completion information of the plurality of security measures.

S603: aggregately displaying, in a display region corresponding to the security scenario, information of a plurality of anomaly categories associated with the security scenario, where an anomaly category indicated by the anomaly category information is related to the anomaly identification rule.

S604: displaying an anomaly detail chart corresponding to the security scenario in response to an anomaly detail viewing instruction for the security scenario; where the anomaly detail chart includes an anomaly distribution map within a preset time period and a list of anomaly objects.

In this embodiment, for the specific implementations of the above steps S601 to S604, reference may be made to the descriptions corresponding to steps S301 to S304 in the embodiment shown in FIG. 3, which will not be repeated here.

S605: displaying anomaly disposal information for performing anomaly disposal on an anomaly object, where the anomaly disposal information is used for handling an anomaly corresponding to at least one anomaly object.

In an application scenario, the above anomaly disposal information is displayed in the anomaly detail chart or in the object anomaly information interface, for example, the disposal information 43 displayed in FIG. 4. In the disposal information 43, reasons for disposing the anomaly may be displayed: “When there are many document anomalies in the user group, it may lead to improper dissemination of key information and data, causing information security issues. Therefore, it is recommended to check the documents. If the problem persists to store”, and the disposal measures: “It is recommended to use measure A and measure B for disposal”.

When performing anomaly disposal, the user may enter configuration interfaces corresponding to the measure A and the measure B respectively, and apply the measure A and the measure B to the security protection of the user group.

Specifically, for example, the user may exit the security overview dashboard and enter a configuration interface corresponding to a specific security item, such as an interface corresponding to a data protection security item. The user may apply the measure A and the measure B to the security protection of the user group in this interface.

For another example, the above measure A and measure B are linked to configuration interfaces. The user may click on the measure A or the measure B to enter the corresponding configuration interface, and apply the measure A or the measure B to the security protection of the user group in the configuration interface.

In some application scenarios, the above anomaly disposal information may also be displayed in the object anomaly information interface. As shown in FIG. 5, the anomaly disposal information “How to check and handle anomalies” is displayed in the object anomaly information interface 50.

In some embodiments, the disposal information includes a disposal guiding control, and the method further includes:
first, receiving a disposal policy display instruction triggered by performing a preset operation on the disposal guiding control, and displaying a disposal policy information interface for the anomaly object, the disposal policy information interface including a disposal entry; and
second, entering a disposal interface in response to an operation on the disposal entry, the disposal interface being used for disposing the anomaly object.

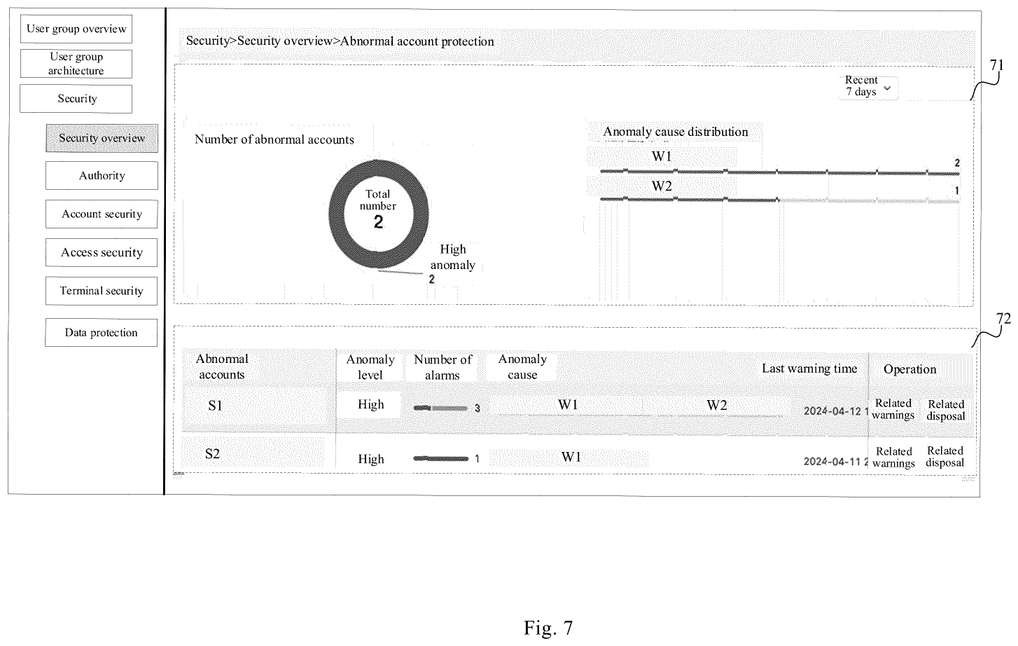

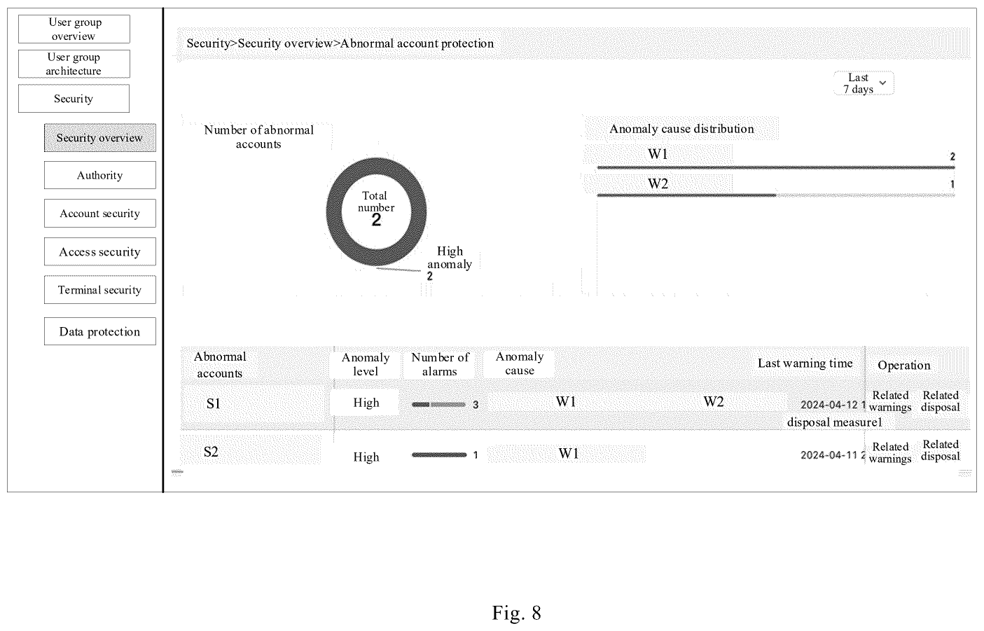

Please refer to FIG. 7 and FIG. 8. FIG. 7 is a schematic diagram of an application scenario, and FIG. 8 is a schematic diagram of an application scenario. The user may perform an anomaly detail viewing instruction for the security scenario of abnormal account protection in the security overview dashboard, and then the anomaly detail chart corresponding to the abnormal account protection is displayed as shown in FIG. 7. In FIG. 7, an anomaly distribution map 71 and a list of anomaly objects 72 within a preset time period may be displayed, and the preset time period is “Recent 7 days”. The anomaly distribution map 71 includes an abnormal account distribution map and an anomaly cause distribution map within the preset time period, and displays information about abnormal accounts within the preset time period, for example, the total number of abnormal accounts is 2, the 2 abnormal accounts correspond to a high anomaly level, the anomaly cause distribution corresponding to the two abnormal accounts is “W1”, and the corresponding number is “2” accounts, etc.

The list of anomaly objects 72 may include information of anomaly objects within the recent 7 days. In this security scenario, the anomaly objects are abnormal accounts. For example, anomaly information of abnormal accounts “S1” and “S2” is displayed in the list of anomaly objects 72, for example, information such as anomaly levels, the number of alarms, anomaly cause, the last warning time, and corresponding operations of the abnormal accounts. For example, the anomaly level corresponding to the abnormal account “S1” is “High”, the number of alarms is “3”, the anomaly cause is anomaly categories “W1” and “W2”, the last alarm event was on 2024-04-12, and the corresponding operations include “Related warnings” and “Related disposal”. For example, the anomaly level corresponding to the abnormal account “S2” is “High”, the number of alarms is “1”, the anomaly cause is the anomaly category “W1”, the last alarm event was on 2024-04-11, and the corresponding operations include “Related warnings” and “Related disposal”.

In the above list of anomaly objects, a disposal guiding control “Related disposal” may be displayed. The user may perform a preset operation such as hovering on the above disposal guiding control for the anomaly object, so that indication information of a corresponding disposal policy may be displayed. As shown in FIG. 8, the indication information of the disposal policy “Disposal measure 1” is displayed in the form of a floating window or a pop-up window.

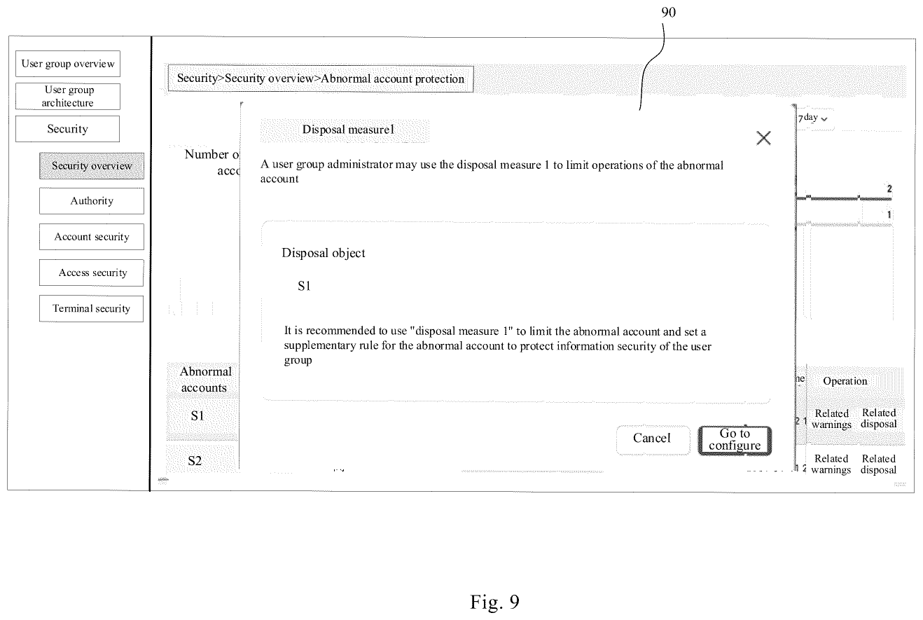

Optionally, a touch or click operation may be performed on the above indication information of the disposal policy, so that a disposal policy display instruction for the anomaly object is issued. After receiving the disposal policy instruction, the above execution subject may display a disposal policy information interface, such as a disposal policy information interface 90 shown in FIG. 9. In the above disposal policy information interface 90, the disposal policy corresponding to the measure 1 and description information of the disposal policy are displayed: “A user group administrator may use the disposal measure 1 to limit operations of the abnormal account”, information of a disposal object “S1”, and a disposal suggestion for the disposal object “It is recommended to use “Disposal measure 1” to limit the abnormal account and set a supplementary rule for the abnormal account to protect information security of the user group”. In addition, a disposal entry “Go to configure” is also displayed in the disposal policy information interface 90. The user may perform a trigger operation on the above disposal entry to enter a configuration interface corresponding to the measure 1, and the measure 1 may be applied to the anomaly object “S1” in the configuration interface corresponding to the measure 1.

In these embodiments, the user is presented with the disposal guiding control, the display of the disposal policy information interface is triggered according to the user's operation on the disposal guiding control, the details of the disposal policy and the disposal recommendation for the anomaly object are displayed in the above policy information interface, and the disposal entry is provided. Therefore, the user can be provided with a closed link for anomaly discovery and disposal, and the efficiency of discovering the security issues of the information in the user group and solving the security issues emerging in the user group can be improved.

As another implementation, the disposal information includes a disposal control for the anomaly object, and the method further includes:
performing a target disposal operation for the anomaly object in response to receiving a trigger operation performed on the disposal control, the target disposal operation being associated with the disposal control.

Continuing referring to FIG. 7, the “Related disposal” for the of abnormal accounts in the above list of anomaly objects is the disposal control. The above disposal control is associated with a corresponding disposal operation. For example, the user may perform a preset operation on the disposal control corresponding to the abnormal account S2. Since the above disposal control is associated with the disposal operation corresponding to the abnormal account, such as disposal measure 1, etc., the efficiency of solving the information security anomalies of the user group can be further improved.

In some embodiments of the method of security information visualization processing shown in FIG. 1, FIG. 3 and FIG. 6, the security measure aggregation information includes:
displaying applied security measures and unapplied security measures in different regions of the security overview dashboard.

Referring to FIG. 2, in the security overview dashboard in FIG. 2, the region 25 displays unapplied security measures “Measure 1”, “Measure 2”, “Measure 3”, “Measure 4”, and “Measure 5”, and the region 26 displays applied security measures: “Measure 6”, “Measure 7”, and “Measure 8”.

The unapplied security measures here refer to security measures that have not been applied to the information security prevention of the user group. The applied security measures refer to security measures that have been applied to the information security prevention of the user group.

The security measures and the unapplied security measures are displayed in different regions, which is beneficial for the user to quickly know which security measures are unapplied, so as to apply these measures to the information security prevention, thereby improving the security of the information in the user group.

In some embodiments of the method of security information visualization processing shown in FIG. 1, FIG. 3 and FIG. 6, the method further includes the following steps.

First, for an unapplied security measure, displaying an application prompt control corresponding to the unapplied security measure.

Then, in response to a trigger operation performed on the application prompt control of the unapplied security measure, displaying an application interface corresponding to the security measure. The application interface is used for applying the unapplied security measure to the information security protection of the user group.

As an implementation, a corresponding application prompt control may be displayed for each unapplied security measure.

As another implementation, one application prompt control may be displayed in the security overview dashboard. The user may first select an unapplied security measure, and then trigger the application prompt control, so as to trigger the application prompt control for the unapplied security measure.

Continue to refer to FIG. 2, in FIG. 2, for the unapplied security measures “Measure 1”, “Measure 2”, “Measure 3”, “Measure 4” and “Measure 5”, an application prompt control “Go to configure” is displayed in the region 25. The user may perform a trigger operation on the application prompt control corresponding to the unapplied security measure to enter an application interface corresponding to the security measure. Corresponding operations may be performed in the application interface to apply the security measure to the information security prevention of the user group.

In these embodiments, the application prompt control is displayed, so that it is convenient for the user to apply the unapplied security measure to the information security of the user group, and the efficiency of applying these security measures to the user group can be improved.

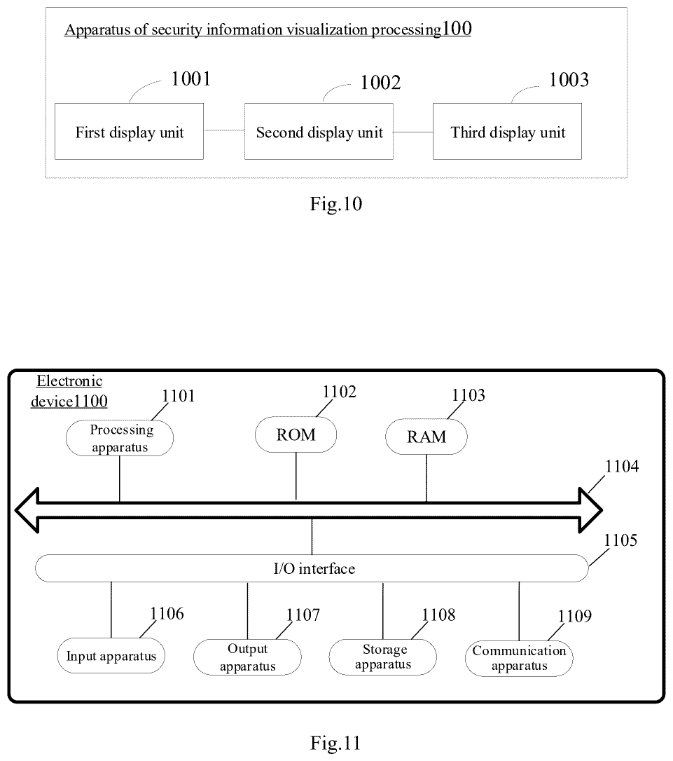

Corresponding to the method of security information visualization processing of the above embodiments, FIG. 10 is a structural block diagram of an apparatus of security information visualization processing according to an embodiment of the present disclosure. For the ease of explanation, only parts related to the embodiments of the present disclosure are shown. Referring to FIG. 10, the apparatus 100 includes: a first display unit 1001, a second display unit 1002, and a third display unit 1003.

The first display unit 1001 is configured to display a security overview dashboard of a user group in response to a security overview display instruction;
the second display unit 1002 is configured to display anomaly aggregation information and security measure aggregation information in the security overview dashboard, where the anomaly aggregation information includes anomaly aggregation data respectively corresponding to a plurality of security scenarios; where the anomaly aggregation data corresponding to each security scenario is obtained based on: performing anomaly object identification on a plurality of pieces of log data based on an anomaly identification rule associated with the security scenario, and aggregating anomaly data of obtained anomaly objects; the security measure aggregation information includes information of a plurality of security measures corresponding to the user group and completion information of the plurality of security measures; and
the third display unit 1003 is configured to aggregately display, in a display region corresponding to the security scenario, information of a plurality of anomaly categories associated with the security scenario, where an anomaly category indicated by the anomaly category information is related to the anomaly identification rule.

In some embodiments, the security scenario includes:
a content security scenario, an account security protection scenario, and an abnormal account protection scenario.

In some embodiments, the apparatus 100 further includes a rule modification unit (not shown in the figure), and the rule modification unit is configured to:
receive a modification instruction for modifying an anomaly identification rule; and
modify the anomaly identification rule according to the modification instruction.

In some embodiments, a rule configuration entry is displayed in the security overview dashboard displayed by the first display unit; and the rule modification unit is further configured to:
receive the modification instruction sent based on an operation on the anomaly identification rule configuration entry.

In some embodiments, the apparatus 100 further includes a fourth display unit (not shown in the figure), and the fourth display unit is configured to:
display an anomaly detail chart corresponding to the security scenario in response to an anomaly detail viewing instruction for the security scenario.

The anomaly detail chart includes an anomaly distribution map within a preset time period and a of anomaly objects; and

The list of anomaly objects includes information of a plurality of anomaly objects.

In some embodiments, a first viewing control for viewing the anomaly detail of the security scenario is further displayed in the security overview dashboard; and the fourth display unit is further configured to:
receive the anomaly detail viewing instruction triggered by performing a preset operation on the first viewing control of the security scenario.

In some embodiments, the security scenario is a content security scenario, and the list of anomaly objects includes at least one piece of anomalous content whose content state is a to-be-concerned state.

The content state includes the to-be-concerned state and a no-need-to-concern state, and the content state of the content is determined according to a content state determination rule.

In some embodiments, the apparatus 100 further includes a fifth display unit (not shown in the figure), and the fifth display unit is configured to:
display an object anomaly information interface of a target anomaly object in response to receiving an anomaly object detail display instruction triggered based on an anomaly object detail control; where the target anomaly object is an anomaly object indicated by the anomaly object detail display instruction, and the object anomaly information interface includes anomaly detail information corresponding to the target anomaly object.

In some embodiments, the apparatus 100 further includes a sixth display unit (not shown in the figure), and the sixth display unit is configured to:
display anomaly disposal information for performing anomaly disposal on an anomaly object, where the anomaly disposal information is used for handling an anomaly corresponding to at least one anomaly object.

In some embodiments, the disposal information is displayed in the anomaly detail chart or in the object anomaly information interface.

In some embodiments, the disposal information includes a disposal guiding control, and the apparatus 100 further includes a first anomaly disposal unit (not shown in the figure), and the first anomaly disposal unit is configured to:
receive a disposal policy display instruction triggered by performing a preset operation on the disposal guiding control, and display a disposal policy information interface for the anomaly object, the disposal policy information interface including a disposal entry; and
enter a disposal interface in response to an operation on the disposal entry, the disposal interface being used for disposing the anomaly object.

In some embodiments, the disposal information includes a disposal control for the anomaly object; the apparatus 100 further includes a second anomaly disposal unit (not shown in the figure), and the second anomaly disposal unit is configured to: perform a target disposal operation for the anomaly object in response to receiving a trigger operation performed on the disposal control, the target disposal operation being associated with the disposal control.

In some embodiments, the security measure aggregation information includes: applied security measures and unapplied security measures displayed in different regions of the security overview dashboard.

In some embodiments, the apparatus 100 further includes a security measure application unit (not shown in the figure), and the security measure application unit is configured to:
display an application prompt control corresponding to an unapplied security measure for the unapplied security measures; and
display an application interface corresponding to an unapplied security measure in response to a trigger operation performed on the application prompt control of the unapplied security measure, the application interface being used for applying the unapplied security measure to information security protection of the user group.

In order to implement the above embodiments, an embodiment of the present disclosure further provides an electronic device.

Referring to FIG. 11, it shows a schematic structural diagram of an electronic device 1100 suitable for implementing the embodiments of the present disclosure. The electronic device 1100 may be a terminal device or a server. The terminal device may include, but is not limited to, mobile terminals such as a mobile phone, a laptop, a digital broadcast receiver, a personal digital assistant (abbreviated as PDA), a tablet computer, a portable media player (abbreviated as PMP), a vehicle-mounted terminal (such as a vehicle navigation terminal), etc., and fixed terminals such as a digital TV, a desktop computer, etc. The electronic device shown in FIG. 11 is only an example, and should not bring any limitation to the functions and scope of use of the embodiments of the present disclosure.

As shown in FIG. 11, the electronic device 1100 may include a processing apparatus (such as a central processing unit, a graphics processing unit, etc.) 1101, which may perform various appropriate actions and processes according to a program stored in a read-only memory (abbreviated as ROM) 1102 or a program loaded from a storage apparatus 1108 into a random access memory (abbreviated as RAM) 1103. The RAM 1103 further stores various programs and data required for the operation of the electronic device 1100. The processing apparatus 1101, the ROM 1 1102, and the RAM 1103 are connected to each other through a bus 1104. An input/output (I/O) interface 1105 is also connected to the bus 1104.

Generally, the following apparatuses may be connected to the I/O interface 1105: an input apparatus 1106 including, for example, a touchscreen, a touchpad, a keyboard, a mouse, a camera, a microphone, an accelerometer, a gyroscope, etc.; an output apparatus 1107 including, for example, a liquid crystal display (Liquid Crystal Display, LCD for short), a speaker, a vibrator, etc.; a storage apparatus 1108 including, for example, a magnetic tape, a hard disk, etc.; and a communication apparatus 1109. The communication apparatus 1109 may allow the electronic device 1100 to perform wireless or wired communication with other devices to exchange data. Although FIG. 11 shows the electronic device 1100 having various apparatuses, it should be understood that it is not required to implement or have all of the illustrated apparatuses. More or fewer apparatuses may alternatively be implemented or provided.

Particularly, according to the embodiments of the present disclosure, the processes described above with reference to the flowcharts may be implemented as a computer software program. For example, the embodiments of the present disclosure include a computer program product, which includes a computer program carried on a computer-readable medium, where the computer program includes program codes for executing the method shown in the flowchart. In such an embodiment, the computer program may be downloaded and installed from a network through the communication apparatus 1109, or installed from the storage apparatus 1108, or installed from the ROM 1102. When the computer program (computer-executable instructions) is executed by the processing apparatus 1101, the above functions defined in the method of the embodiments of the present disclosure are executed.

It should be noted that the above computer-readable medium in the present disclosure may be a computer-readable signal medium or a computer-readable storage medium or any combination thereof. The computer-readable storage medium may be, for example but not limited to, an electrical, magnetic, optical, electromagnetic, infrared, or semiconductor system, apparatus, or device, or any combination thereof. More specific examples of the computer-readable storage medium may include but are not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program, which may be used by or in combination with an instruction execution system, apparatus, or device. In the present disclosure, the computer-readable signal medium may include a data signal propagated in a baseband or as a part of a carrier, and computer-readable program codes are carried in the data signal. The data signal propagated in this manner may take a plurality of forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program for use by or in combination with an instruction execution system, apparatus, or device. The program codes contained on the computer-readable medium may be transmitted by any suitable medium, including but not limited to: a wire, an optical cable, an RF (radio frequency), etc., or any suitable combination thereof.

The above computer-readable medium may be included in the above electronic device, or may exist alone without being assembled into the electronic device.

The above computer-readable medium carries one or more programs (computer-executable instructions), and when the one or more programs are executed by the electronic device, the electronic device is enabled to execute the method shown in the above embodiments.

The computer program codes for executing the operations of the present disclosure may be written in one or more programming languages or a combination thereof. The above programming languages include object-oriented programming languages such as Java, Smalltalk, C++, and also include conventional procedural programming languages such as “C” language or similar programming languages. The program codes may be completely executed on a user computer, partially executed on a user computer, executed as an independent software package, partially executed on a user computer and partially executed on a remote computer, or completely executed on a remote computer or server. In the case of involving a remote computer, the remote computer may be connected to a user computer through any kind of network, including a local area network (abbreviated as LAN)) or a wide area network (abbreviated as WAN), or may be connected to an external computer (for example, connected via the Internet using an Internet service provider).

The flowcharts and block diagrams in the drawings illustrate the possible architecture, functions and operations of the system, method and computer program product according to the embodiments of the present disclosure. In this regard, each block in the flowcharts or block diagrams may represent a module, a program segment, or a part of codes, and the module, the program segment, or the part of codes contains one or more executable instructions for implementing a specified logical function. It should also be noted that in some alternative implementations, the functions marked in the blocks may also occur in a different order from the order marked in the drawings. For example, two blocks shown one after another may actually be executed substantially in parallel, and sometimes they may be executed in a reverse order, which depends on the functions involved. It should also be noted that each block in the block diagrams and/or flowcharts, and a combination of the blocks in the block diagrams and/or flowcharts may be implemented by a dedicated hardware-based system for executing specified functions or operations, or may be implemented by a combination of dedicated hardware and computer instructions.

The units involved in the embodiments of the present disclosure may be implemented by software or hardware. The name of a unit does not constitute a limitation on the unit itself under certain circumstances.

The functions described above herein may be performed, at least in part, by one or more hardware logic components. For example, without limitation, exemplary types of hardware logic components that may be used include: a field programmable gate array (FPGA), an application specific integrated circuit (ASIC), an application specific standard product (ASSP), a system on a chip (SOC), a complex programmable logic device (CPLD), etc.

In the context of the present disclosure, a machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

The above description is only preferred embodiments of the present disclosure and an illustration of the applied technical principles. It should be understood by those of ordinary skill in the art that the scope of disclosure involved in the present disclosure is not limited to the technical solutions formed by a specific combination of the above technical features, but should also cover other technical solutions formed by any combination of the above technical features or their equivalent features without departing from the above disclosed concept, for example, technical solutions formed by replacing the above features with technical features having similar functions disclosed in the present disclosure (but not limited to).

In addition, although operations are depicted in a specific order, this should not be understood as requiring these operations to be performed in the specific order shown or in a sequential order. Under certain circumstances, multitasking and parallel processing may be advantageous. Similarly, although several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or logical actions of methods, it should be understood that the subject matter defined in the appended claims is not necessarily limited to the specific features or actions described above. On the contrary, the specific features and actions described above are merely exemplary forms for implementing the claims.

1. A method of security information visualization processing, comprising:
displaying a security overview dashboard of a user group in response to a security overview display instruction;
displaying anomaly aggregation information and security measure aggregation information in the security overview dashboard, wherein the anomaly aggregation information comprises anomaly aggregation data respectively corresponding to a plurality of security scenarios; wherein the anomaly aggregation data corresponding to each security scenario is obtained based on: performing anomaly object identification on a plurality of pieces of log data based on an anomaly identification rule associated with the security scenario, and aggregating anomaly data of obtained anomaly objects; the security measure aggregation information comprises information of a plurality of security measures corresponding to the user group and completion information of the plurality of security measures; and
aggregately displaying, in a display region corresponding to the security scenario, information of a plurality of anomaly categories associated with the security scenario, wherein an anomaly category indicated by the anomaly category information is related to the anomaly identification rule.

2. The method according to claim 1, wherein the security scenario comprises at least one of the group consisting of the following:
a content security scenario, an account security protection scenario, or an abnormal account protection scenario.

3. The method according to claim 1, further comprising:
receiving a modification instruction for modifying the anomaly identification rule; and
modifying the anomaly identification rule according to the modification instruction.

4. The method according to claim 3, wherein the security overview dashboard comprises an anomaly identification rule configuration entry; and the receiving the modification instruction for modifying the anomaly identification rule comprises:
receiving the modification instruction sent based on an operation on the anomaly identification rule configuration entry.

5. The method according to claim 1, further comprising:
displaying an anomaly detail chart corresponding to the security scenario in response to an anomaly detail viewing instruction for the security scenario;
wherein the anomaly detail chart comprises an anomaly distribution map within a preset time period and a list of anomaly objects; and
the list of anomaly objects comprises information of a plurality of anomaly objects.

6. The method according to claim 5, wherein a first viewing control for viewing the anomaly detail chart of the security scenario is further displayed in the security overview dashboard; and the method further comprises:
receiving the anomaly detail viewing instruction triggered by performing a preset operation on the first viewing control of the security scenario.

7. The method according to claim 5, wherein the security scenario is a content security scenario, and the list of anomaly objects comprises at least one piece of anomalous content whose content state is a to-be-concerned state;
wherein the content state comprises the to-be-concerned state and a no-need-to-concern state, and the content state of the content is determined according to a content state determination rule.

8. The method according to claim 5, further comprising:
displaying an object anomaly information interface of a target anomaly object in response to receiving an anomaly object detail display instruction triggered based on an anomaly object detail control; wherein the target anomaly object is an anomaly object indicated by the anomaly object detail display instruction, and the object anomaly information interface comprises anomaly detail information corresponding to the target anomaly object.

9. The method according to claim 1, further comprising:
displaying anomaly disposal information for performing anomaly disposal on an anomaly object, wherein the anomaly disposal information is configured to handle an anomaly corresponding to at least one anomaly object.

10. The method according to claim 9, wherein the anomaly disposal information is displayed in the anomaly detail chart or in the object anomaly information interface.

11. The method according to claim 9, wherein the anomaly disposal information comprises a disposal guiding control, and the method further comprises:
receiving a disposal policy display instruction triggered by performing a preset operation on the disposal guiding control, and displaying a disposal policy information interface for the anomaly object, the disposal policy information interface comprising a disposal entry; and
entering a disposal interface in response to an operation on the disposal entry, the disposal interface being used for disposing the anomaly object.

12. The method according to claim 9, wherein the disposal information comprises a disposal control for the anomaly object; and the method further comprises:
performing a target disposal operation for the anomaly object in response to receiving a trigger operation performed on the disposal control, the target disposal operation being associated with the disposal control.

13. The method according to claim 1, wherein the security measure aggregation information comprises:
applied security measures and unapplied security measures displayed in different regions of the security overview dashboard.

14. The method according to claim 13, further comprising:
displaying an application prompt control corresponding to an unapplied security measure for the unapplied security measures; and
displaying an application interface corresponding to an unapplied security measure in response to a trigger operation performed on the application prompt control of the unapplied security measure, the application interface being configured to apply the unapplied security measure to information security protection of the user group.

15. The method according to claim 2, wherein the security measure aggregation information comprises:
applied security measures and unapplied security measures displayed in different regions of the security overview dashboard.

16. The method according to claim 3, wherein the security measure aggregation information comprises:
applied security measures and unapplied security measures displayed in different regions of the security overview dashboard.

17. The method according to claim 1, wherein the security measure aggregation information comprises:
applied security measures and unapplied security measures displayed in different regions of the security overview dashboard.

18. The method according to claim 4, wherein the security measure aggregation information comprises:
applied security measures and unapplied security measures displayed in different regions of the security overview dashboard.

19. An electronic device, comprising: at least one processor and at least one memory;
wherein the at least one memory stores computer-executable instructions; and
the at least one processor executes the computer-executable instructions stored in the at least one memory to enable the processor to execute a method of security information visualization processing, which comprise:
displaying a security overview dashboard of a user group in response to a security overview display instruction;
displaying anomaly aggregation information and security measure aggregation information in the security overview dashboard, wherein the anomaly aggregation information comprises anomaly aggregation data respectively corresponding to a plurality of security scenarios; wherein the anomaly aggregation data corresponding to each security scenario is obtained based on: performing anomaly object identification on a plurality of pieces of log data based on an anomaly identification rule associated with the security scenario, and aggregating anomaly data of obtained anomaly objects; the security measure aggregation information comprises information of a plurality of security measures corresponding to the user group and completion information of the plurality of security measures; and
aggregately displaying, in a display region corresponding to the security scenario, information of a plurality of anomaly categories associated with the security scenario, wherein an anomaly category indicated by the anomaly category information is related to the anomaly identification rule.

20. A non-transitory computer-readable storage medium, wherein the computer-readable storage medium stores computer-executable instructions, and when a processor executes the computer-executable instructions, a method of security information visualization processing is implemented, and the method comprises:
displaying a security overview dashboard of a user group in response to a security overview display instruction;
displaying anomaly aggregation information and security measure aggregation information in the security overview dashboard, wherein the anomaly aggregation information comprises anomaly aggregation data respectively corresponding to a plurality of security scenarios; wherein the anomaly aggregation data corresponding to each security scenario is obtained based on: performing anomaly object identification on a plurality of pieces of log data based on an anomaly identification rule associated with the security scenario, and aggregating anomaly data of obtained anomaly objects; the security measure aggregation information comprises information of a plurality of security measures corresponding to the user group and completion information of the plurality of security measures; and
aggregately displaying, in a display region corresponding to the security scenario, information of a plurality of anomaly categories associated with the security scenario, wherein an anomaly category indicated by the anomaly category information is related to the anomaly identification rule.
